(19) United States
(12) Patent Application Publication
(10) Pub. No.: US 2026/0252214 A1
(43) Pub. Date: Aug. 27, 2026

(54) INTERACTION METHOD AND APPARATUS, ELECTRONIC DEVICE, AND STORAGE MEDIUM

(71) Applicant: Beijing Zitiao Network Technology Co., Ltd., Beijing (CN)

(72) Inventors: Weiyi CHANG, Beijing (CN); Zhimiao HE, Beijing (CN); Zhehao YOU, Beijing (CN); Yuze SUN, Beijing (CN); Huiru YANG, Beijing (CN)

(21) Appl. No.: 18/875,011

(22) PCT Filed: Jun. 21, 2023
(86) PCT No.: PCT/CN2023/101656

§ 371 Date: Dec. 13, 2024

(30) Foreign Application Priority Data
Jun. 22, 2022 (CN) 202210715868.4

(51) Int. Cl. G06F 3/0484; G06F 3/04815; G06F 3/0482

(52) U.S. Cl. CPC G06F 3/0484; G06F 3/04815; G06F 3/0482

(57) ABSTRACT

The disclosed embodiments provide a method for interaction, apparatus, electronic device and storage medium. The method comprises: in response to a display operation, displaying a user avatar interface, wherein user avatars of at least two user are displayed in the user avatar interface; determining a target user avatar in the user avatar interface, the target user avatar is one of the user avatars of the at least two users; in response to an interactive operation for the target interface, executing an interactive event of a target user corresponding to the target user avatar, the target interface supporting different types of interactive operations, the different types of interactive operations corresponding to different types of interactive events, and the target interface including the user avatar interface.

### CROSS REFERENCE TO RELATED APPLICATIONS

This application claims the priority of the Chinese patent application filed with the China Patent Office on Jun. 22, 2022, with application number 202210715868.4, the contents of which are incorporated herein in its entirety.

### FIELD

The embodiments of the present disclosure relate to the field of computer technology, for example, to a method, apparatus, electronic device and storage medium for interaction.

### BACKGROUND

In the related technology, a user can view his or her own or other users' virtual avatars in a virtual avatar interface. However, the interactive operations that the user can perform based on the virtual avatar are relatively simple.

### SUMMARY

The disclosed embodiment provides method, apparatus, electronic device and storage medium for interaction to provide diversified virtual avatar interaction modes.

The disclosed embodiment provides a method for interaction, including:
in response to a display operation, displaying a user avatar interface, wherein user avatars of at least two users are displayed in the user avatar interface;
determining a target user avatar in the user avatar interface, and the target user avatar is one of the user avatars of the at least two users;
in response to an interactive operation for the target interface, executing an interactive event of a target user corresponding to the target user avatar, the target interface supporting different types of interactive operations, the different types of interactive operations corresponding to different types of interactive events, and the target interface including the user avatar interface.

The embodiment of the present disclosure also provides an apparatus for interaction, including:
an interface display module, configured to display a user avatar interface in response to a display operation, wherein user avatars of at least two users are displayed in the user avatar interface;
an avatar determination module, configured to determine a target user avatar, wherein the target user avatar is one of the user avatars of the at least two users;
an interactive module, configured to execute an interactive event of a target user corresponding to the target user avatar in response to an interactive operation for the target interface, the target interface supporting different types of interactive operations, the different types of interactive operations corresponding to different interactive events, and the target interface including the user avatar interface.

The embodiment of the present disclosure also provides an electronic device, including:
one or more processors;
a memory, configured to store one or more programs;
when the one or more programs are executed by the one or more processors, causing the one or more processors to implement the method for interaction as described in the embodiment of the present disclosure.

The embodiment of the present disclosure also provides a computer-readable storage medium, wherein a computer program is stored on the computer-readable storage medium, and when the program is executed by the processor, the method for interaction as described in the embodiment of the present disclosure is implemented.

The embodiment of the present disclosure also provides a computer program product, wherein when the computer program product is executed by a computer, the computer implements the method for interaction as described in the embodiment of the present disclosure.

### BRIEF DESCRIPTION OF THE FIGURES

In all figures, the same or similar reference numerals represent the same or similar elements. It should be understood that the figures are schematic, and the originals and elements are not necessarily drawn to scale.

FIG. 1 is a flowchart of a method for interaction provided in an embodiment of the present disclosure;

FIG. 2 is a display diagram of a user avatar interface provided in an embodiment of the present disclosure;

FIG. 3 is a flowchart of another method for interaction provided in an embodiment of the present disclosure;

FIG. 4a is a display diagram of an avatar display interface provided in an embodiment of the present disclosure;

FIG. 4b is a display diagram of an interactive panel provided in an embodiment of the present disclosure;

FIG. 5 is a display diagram of a media content interface provided in an embodiment of the present disclosure;

FIG. 6 is a flowchart of another method for interaction provided in an embodiment of the present disclosure;

FIG. 7 is a structural block diagram of a device for interaction provided in an embodiment of the present disclosure;

FIG. 8 is a structural diagram of an electronic device provided in an embodiment of the present disclosure.

### DETAILED DESCRIPTION OF EMBODIMENTS

The following will describe the embodiments of the present disclosure with reference to the accompanying drawings. It should be understood that the drawings and embodiments of the present disclosure are only for illustrative purposes and are not intended to limit the scope of protection of the present disclosure.

It should be understood that the multiple steps recorded in the method implementation of the present disclosure can be performed in different orders and/or in parallel. In addition, the method implementation may include additional steps and/or omit the steps shown. The scope of the present disclosure is not limited in this respect.

The term “including” and its variations used herein are open inclusions, that is, “including but not limited to”. The term “based on” means “at least partially based on”. The term “one embodiment” means “at least one embodiment”; the term “another embodiment” means “at least one other embodiment”; the term “some embodiments” means “at least some embodiments”. The relevant definitions of other terms will be given in the following description.

It should be noted that the concepts of “first”, “second”, etc. mentioned in the present disclosure are only used to distinguish different apparatus, modules or units, and are not used to limit the order or interdependence of the functions performed by these apparatus, modules or units.

It should be noted that the modifications of “one” and “multiple” mentioned in the present disclosure are illustrative rather than restrictive. Those skilled in the art should understand that unless otherwise clearly indicated in the context, they should be understood as “one or more”.

The names of the messages or information exchanged between the multiple apparatus in the embodiments of the present disclosure are only for illustrative purposes, and are not used to limit the scope of these messages or information.

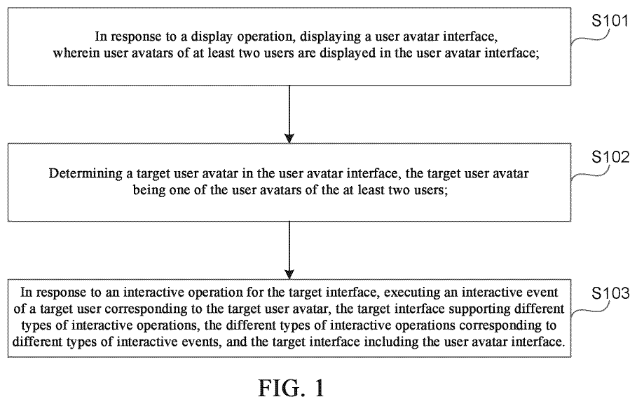

FIG. 1 is a flow chart of a method for interaction provided in an embodiment of the present disclosure. The method can be executed by an interaction apparatus, wherein the apparatus can be implemented by software and/or hardware, and can be configured in an electronic device, such as a mobile phone or a tablet computer. The method for interaction provided in the embodiment of the present disclosure is suitable for scenarios based on virtual avatar interaction. As shown in FIG. 1, the method for interaction provided in this embodiment may include:

S101, in response to a display operation, displaying a user avatar interface, wherein user avatars of at least two users are displayed in the user avatar interface.

In this embodiment, the display operation may be understood as an operation for indicating the display of a user avatar interface, such as an operation for triggering a user identifier displayed in a preset interface. The user avatar interface may be a interface for displaying user avatars of different users, such as an interface for displaying the user avatar of the current user and the user avatar of at least one associated user of the current user. The user avatar may include a virtual avatar and/or a non-virtual avatar, that is, the user avatars of the at least two users may be virtual avatars and/or non-virtual avatars corresponding to each of the at least two users.

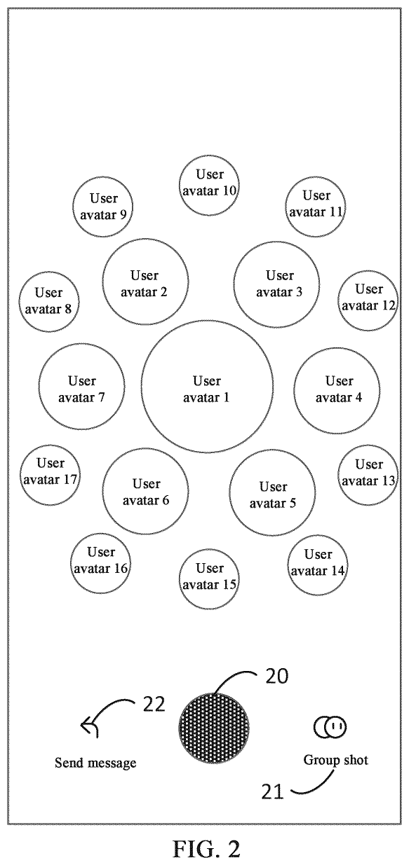

When a display operation is received, the user avatar interface may be displayed, and the user avatars of at least two users may be displayed in the user avatar interface, as shown in FIG. 2.

When the user avatars of multiple users are displayed in the user avatar interface, the arrangement of the multiple user avatars in the user avatar interface may be flexibly set, such as the multiple user avatars may be arranged in a horizontal queue and/or a vertical queue in the user avatar interface; the multiple user avatars may also be arranged according to the relationship between each associated user and the current user, such as arranging the user avatars of multiple associated users of the current user according to the relationship between each associated user and the current user, with the user avatar of the current user as the center.

The user avatars of multiple associated users may be arranged in a plane or a curved surface. Alternatively, multiple user avatars are arranged in a curved surface in the user avatar interface, such as multiple user avatars may be arranged on a preset spherical surface, so that the user avatars displayed in the user avatar interface may be switched by displaying the rotation of the sphere to which the spherical surface belongs. Multiple user avatars may be displayed in the user avatar interface in the same or different sizes. For example, the user avatar displayed at a set position (such as the third position) of the user avatar interface may be used as the center, and the display size of each other user avatar in the user avatar interface can be determined according to the distance between each other user avatar and the user avatar at the set position, such as the display size of each other user avatar may be inversely proportional to the distance between the user avatar at the same set position, etc.

In one implementation, the display operation acts on the target user identifier displayed in the preset interface, and the display of the user avatar interface includes: displaying the user avatar interface, and displaying the user avatar of the user corresponding to the target user identifier at the third position of the user avatar interface.

The preset interface may be a interface displaying multiple user identifiers, such as an interface displaying the user identifier of the current user and/or the user identifiers of the current user's associated users, such as the current user's message list interface, the associated user list interface (such as a friend list interface or a follow list interface), etc. The user identifier may include, for example, the user's identity document (ID), avatar, and/or nickname, etc. The third position may be a set position in the user avatar interface, such as the center position of the area for displaying the user avatar in the user avatar interface, etc. The third position may be flexibly set as needed. The target user identifier may be understood as the user identifier on which the display operation acts in the preset interface.

Exemplarily, the electronic device displays preset interface and in the preset interface, displays the user identifier of the current user and/or the user identifiers of multiple associated users of the current user, so that the current user may trigger the user identifier of a user when he wants to view the user avatar of the user. Correspondingly, when the electronic device detects that the current user triggers the user identifier displayed in the preset interface, it may display the user avatar interface, display the user avatar of the user corresponding to the user identifier at the third position of the user avatar interface, and display the user avatar of at least one other user at other positions other than the third position, such as displaying at least two user avatars in the user avatar interface with the user avatar corresponding to the user identifier as the center.

In the above implementation, when the current user views the user identifier in the preset interface, he may switch from the preset interface to the user avatar interface to view the user avatars of multiple users, which can may the operation required for the current user to view the user avatars of different users. In addition, by displaying the user avatar of the user corresponding to the user identifier triggered by the current user at the set position of the user avatar interface, the user may determine the user avatar of the user corresponding to the user identifier triggered by the user without browsing the multiple user avatars in the user avatar interface, and may also facilitate the user to view the user avatar corresponding to the user to whom the user identifier triggered belongs and interact with the user corresponding to the user identifier triggered by the user.

S102, determining the target user avatar in the user avatar interface, wherein the target user avatar is one of the user avatars of the at least two users.

In this embodiment, after the user avatar interface is displayed, the target user avatar can be determined in the user avatar interface to interact with the target user avatar and/or the target user corresponding to the target user avatar.

In this embodiment, the determination method of the target user avatar may be flexibly set, such as determining the user avatar displayed at a set position (such as the third position) of the user avatar interface as the target user avatar, or determining the user avatar triggered by the current user in the user avatar interface as the target user avatar, etc., and this embodiment is not limited by comparison. Exemplarily, when the operation of the current user triggering (such as clicking) a user avatar displayed in the user avatar interface has not been received, the user avatar displayed at the set position in the user avatar interface may be determined as the target user avatar; after the operation of the current user triggering a user avatar displayed in the user avatar interface is received, the user avatar triggered by the current user in the user avatar interface can be determined as the target user avatar.

S103. In response to the interactive operation for the target interface, executing an interactive event of the target user corresponding to the target user avatar, the target interface supporting different types of interactive operations, and the different types of interactive operations corresponding to different types of interactive events, and the target interface including the user avatar interface.

The target interface may be a interface for the current user to perform different types of interactive events based on the target user avatar, and the target interface may include a user avatar interface and/or a target user avatar display interface. The target user avatar display interface may be understood as an interface for displaying the target user avatar, such as the target user avatar may only be displayed in the main display area of the target user avatar display interface.

In this embodiment, the current user may perform different types of interactive operations in the target interface. The different types of interactive operations may include, for example, at least one of an information interaction type interactive operation, a content generation type interactive operation, and a content sharing type interactive operation.

Different types of interactive events related to the target user corresponding to the target user avatar may be performed according to the different types of interactive operations performed by the current user in the target interface. For example, when an information interaction type interactive operation is received, an information interaction type interactive event may be performed, such as sending a conversation message to the target user, sending an emoticon to the target user, liking, commenting on, or following the target user. When a content generation type interactive operation is received, a content generation type interactive event may be performed, such as generating media content containing the target user avatar. When a content sharing type interactive operation is received, an interactive event of the content sharing type may be executed, such as sharing the content to be shared with the target user or sharing a media content stream with the target user in real time.

In one implementation, the method for interaction provided in this embodiment may also include: in response to a virtual avatar setting operation, displaying a virtual avatar setting interface, wherein the virtual avatar setting interface is used to set the virtual avatar of the current user.

The virtual avatar setting operation may be understood as an operation for triggering the setting of a virtual avatar, such as an operation for triggering the virtual avatar setting control displayed in the target interface. The virtual avatar setting control may include, for example, a creation control for triggering the creation of a virtual avatar, an avatar setting control for triggering the setting of the appearance and/or dress of the virtual avatar, and/or an action setting control for triggering the setting of the action performed by the virtual avatar, and so on. Accordingly, the virtual avatar setting interface may include an avatar setting interface and/or an action setting interface.

In this embodiment, the current user may also perform a setting type interactive operation in the target interface, such as performing an interactive operation for setting his own virtual avatar, so as to set his own user avatar.

Exemplarily, when the target user avatar is the user avatar of the current user, if the user avatar of the current user is a non-virtual avatar, the target interface may be a user avatar interface, and a creation control may be displayed in the user avatar interface, so that the current user may create his own virtual avatar by triggering the creation control. Correspondingly, when the electronic device detects that the current user triggers the creation control, it may display an avatar setting interface in the target interface or switch the current interface from the target interface to the avatar setting interface, so that the current user may set the appearance and clothing of the virtual avatar, and may display an action setting interface after the current user completes the setting, so that the current user can set the action performed by the virtual avatar.

If the user avatar of the current user is a virtual avatar, the target interface may be a user avatar interface or an avatar display interface of the current user, and an avatar setting control and an action setting control may be displayed in the user avatar interface, so that the current user may set the appearance and/or clothing of his virtual avatar by triggering the avatar setting control, and may set the action performed by his virtual avatar by triggering the action setting control. Correspondingly, when the electronic device detects that the current user triggers the avatar setting control, the avatar setting interface may be displayed in the target interface or the current interface may be switched from the target interface to the avatar setting interface, so that the current user may set the appearance and clothing of the virtual avatar; when the electronic device detects that the current user triggers the action setting control, the action setting interface may be displayed in the target interface or the current interface may be switched from the target interface to the action setting interface, so that the current user may set the action performed by the virtual avatar.

In this embodiment, the virtual avatar may perform the associated action of the status identification state corresponding to it, so that the current user may set the action performed by the virtual avatar by setting the status identification state corresponding to the virtual avatar. For example, the action setting interface may be set with multiple status identifications for users to select. If the current user does not select any status identification in the action setting interface, the virtual avatar may be displayed to perform a preset action corresponding to the state without a corresponding status identification; if the current user selects a status identification in the action setting interface, the virtual avatar may be displayed to perform an associated action with the status corresponding to the status identification. Among them, the status identification state may be used to identify whether the virtual avatar has a corresponding status identification; the associated action of the status corresponding to each status identification can be preset, and different statuses may have different associated actions.

The method for interaction provided in this embodiment displays a user avatar interface in response to a display operation, wherein user avatars of at least two users are displayed in the user avatar interface; determines a target user avatar in the user avatar interface, and the target user avatar is one of the user avatars of the at least two users; in response to an interactive operation for the target interface, executes an interactive event of the target user corresponding to the target user avatar, and the target interface supports different types of interactive operations, and different types of interactive operations correspond to different types of interactive events, and the target interface includes a user avatar interface. By adopting the above technical solution, this embodiment executes different types of interactive events of the target user corresponding to the target user avatar based on different types of interactive actions, and may provide multiple types of method for interactions based on user avatars to meet different needs of users.

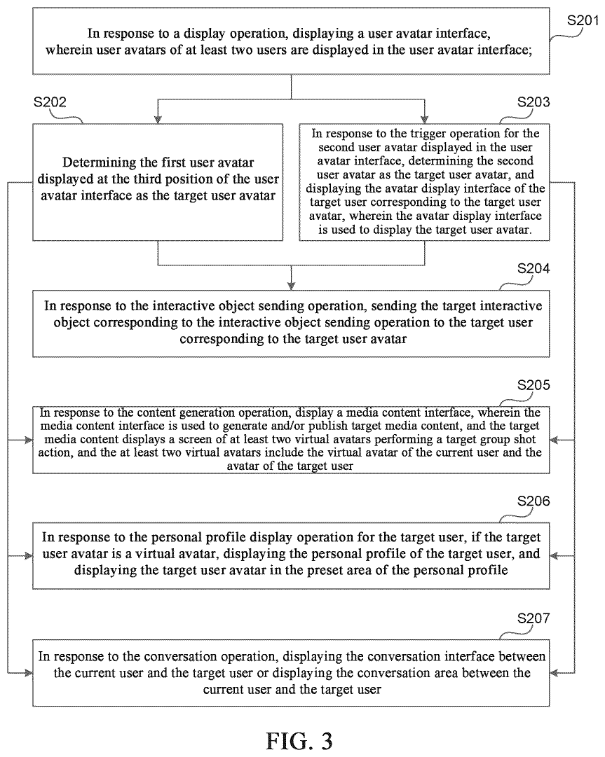

FIG. 3 is a flow chart of another method for interaction provided by an embodiment of the present disclosure. The scheme in this embodiment may be combined with one or more optional schemes in the above embodiments. Alternatively, the interactive operation includes an interactive object sending operation, and the interactive event of the target user corresponding to the target user avatar is executed in response to the interactive operation for the target interface, including: in response to the interactive object sending operation, sending the target interactive object corresponding to the interactive object sending operation to the target user corresponding to the target user avatar.

Alternatively, the interactive operation includes a content generation operation, and the interactive event of the target user corresponding to the target user avatar is executed in response to the interactive operation for the target interface, including: in response to the content generation operation, displaying a media content interface, wherein the media content interface is used to generate and/or publish target media content, and the target media content displays a screen of at least two virtual avatars performing a target group shot action, and the at least two virtual avatars include the virtual avatar of the current user and the target user avatar.

Alternatively, the method for interaction provided by this embodiment also includes: in response to the personal profile display operation for the target user, when the target user avatar is a virtual avatar, displaying the personal profile of the target user, and displaying the target user avatar in a preset area of the personal profile.

Alternatively, the method for interaction provided in this embodiment further includes: in response to the conversation operation, displaying the conversation interface between the current user and the target user or displaying the conversation area between the current user and the target user.

Alternatively, determining the target user avatar in the user avatar interface includes: determining the first user avatar displayed at the third position of the user avatar interface as the target user avatar; or, in response to the trigger operation for the second user avatar displayed in the user avatar interface, determining the second user avatar as the target user avatar, and displaying the avatar display interface of the target user corresponding to the target user avatar, wherein the avatar display interface is used to display the target user avatar.

As shown in FIG. 3, the method for interaction provided in this embodiment may include:

S201, in response to the display operation, displaying the user avatar interface, executing S202 or S203, wherein user avatars of at least two users are displayed in the user avatar interface.

S202, determining the first user avatar displayed at the third position of the user avatar interface as the target user avatar, and executing S204, S205, S206 or S207.

In this embodiment, the target user avatar may be the first user avatar, that is, the first user avatar in the user avatar interface may be determined as the target user avatar. The first user avatar may be understood as the user avatar displayed at the third position of the user avatar interface.

In one implementation, the current user may update the user avatar displayed at the third position of the user avatar interface by executing an update operation, thereby updating the target user avatar and the target user for interaction. Before determining the first user avatar displayed at the third position of the user avatar interface as the target user avatar, it may also include: updating the user avatar displayed at the third position in response to the update operation for the user avatar interface.

The update operation may be understood as an operation for indicating the update of the user avatar displayed at the third position, such as a sliding operation or an operation for triggering an update control.

In this embodiment, the update method of the user avatar displayed at the third position may be flexibly set, such as directly switching the user avatar displayed at the third position, batch switching of multiple user avatars displayed in the user avatar interface, including the user avatar displayed at the third position; or displaying one or more user avatars displayed in the user avatar interface, including the user avatar displayed at the third position, to move, so as to update the user avatar displayed at the third position.

Alternatively, updating of the user avatar displayed at the third position includes: displaying at least two user avatars displayed in the user avatar interface to move, and changing the size of each user avatar based on the movement to update the user avatar displayed at the third position. For example, when multiple user avatars are arranged on a spherical surface, the sphere corresponding to the spherical surface can be displayed to rotate. When a user avatar moves to the third position, the size of the user avatar is increased, and the sizes of the user avatars displayed at other positions except the third position are adjusted according to the distance between other user avatars and the user avatar on the spherical surface, so that the user may quickly determine the target user avatar currently at the third position.

In this embodiment, in the process of updating the user avatar displayed at the third position, the user information of the user corresponding to each user avatar may also be added to the user avatar interface to display, so that the current user may quickly determine the user corresponding to each user avatar, and then quickly move the user avatar of the user that the current user wants to interact with to the third position. Alternatively, the method for interaction provided in this embodiment also includes: in the process of updating the user avatar displayed at the third position, displaying the user information of the user corresponding to each user avatar displayed in the user avatar interface. Among them, the user information may include but is not limited to the user's nickname. When the operation of updating the user avatar displayed at the third position is completed, the user information of the user corresponding to each user avatar may no longer be displayed.

S203, in response to the trigger operation for the second user avatar displayed in the user avatar interface, determining the second user avatar as the target user avatar, and displaying the avatar display interface of the target user corresponding to the target user avatar, and S204, S205, S206 or S207 are executed, wherein the avatar display interface is used to display the target user avatar.

The second user avatar may be understood as the user avatar triggered by the current user in the user avatar interface. The above trigger operation may be understood as an operation to trigger a user avatar displayed in the user avatar interface, and the trigger operation can be a click operation or a drag operation, etc.

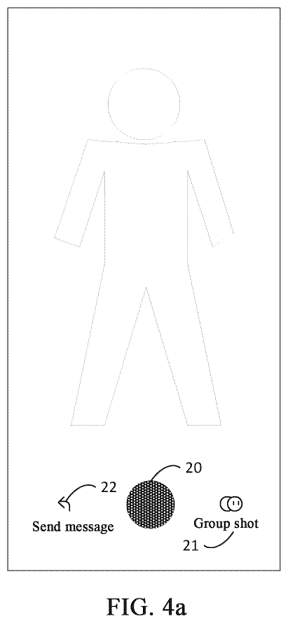

In this embodiment, the target user avatar may also be the second user avatar, that is, the second user avatar in the user avatar interface may be determined as the target user avatar. When it is detected that the current user triggers a user avatar displayed in the user avatar interface, the user avatar can be determined as the target user avatar, the current interface is switched from the user avatar interface to the avatar display interface of the target user, and the target user avatar is displayed separately in the avatar display interface, as shown in FIG. 4a, so as to facilitate the current user to view. Here, the display size of the target user avatar in its avatar display interface may be larger than its display size in the user avatar interface. Wherein, the avatar display interface may be used to display the virtual avatar of the target user.

S204, in response to the interactive object sending operation, sending the target interactive object corresponding to the interactive object sending operation to the target user corresponding to the target user avatar, and terminating the operation.

The interactive object sending operation may be understood as a triggering operation for indicating the sending of an interactive object to the target user corresponding to the target user avatar, such as triggering the interactive control 20 (as shown in FIG. 2 and FIG. 4a) or the interactive object control displayed in the target interface. The target interactive object may be understood as the interactive object sent as instructed by the interactive object sending operation, such as a preset interactive object corresponding to the interactive control 20 or an interactive object corresponding to the interactive object control triggered by the interactive object sending operation. The interactive object may be, for example, an emoticon, a text, or a picture.

In this embodiment, when an interactive object sending operation is received, the target interactive object corresponding to the interactive object sending operation may be sent to the target user corresponding to the target user avatar, such as sending the target interactive object to the target user in the form of a conversation message.

In one implementation, in response to the interactive object sending operation, sending the target interactive object corresponding to the interactive object sending operation to the target user corresponding to the target user avatar includes: in response to a first interactive object sending operation for an interactive control, sending the target interactive object corresponding to the first interactive object sending operation to the target user corresponding to the target user avatar.

The first interactive object sending operation may include an operation of triggering an interactive control displayed in a target interface. The interactive control may be, for example, an interactive panel control for triggering display of an interactive panel, or an interactive object control that is only used to trigger sending an interactive object and corresponds to the interactive object.

In the above embodiment, the interactive control displayed in the target interface may be used to trigger sending the interactive object corresponding to the interactive control.

Exemplarily, the interactive control displayed in the target interface may be one or more interactive object controls. Thus, when it is detected that the current user triggers an interactive control, the interactive object corresponding to the interactive control may be sent to the target user as the target interactive object, and the interactive panel may be displayed or not.

When the current user triggers the interactive control displayed in the target interface, the interactive panel may also be not displayed, but one or more interactive object controls corresponding to the interactive objects can be directly added and displayed in the target interface, and/or one or more other controls displayed in the target interface other than the interactive object control may be replaced with the interactive object control corresponding to the interactive object. When the current condition meets the cancellation display condition of the added interactive object control, the display of the added one or more interactive object controls is cancelled, and the display mode before the interactive object control is restored, and only the initial display and the interactive control in the target interface are displayed. Among them, the cancellation display condition can include, for example, at least one of not receiving a trigger operation for the interactive object control within a preset time length (such as 0.5 s or 1 s, etc.), receiving a trigger operation for the blank space of the target interface, and the avatar of the selected target user changes.

In addition, as shown in FIG. 2 and FIG. 4a, the interactive control 20 displayed in the target interface may also be an interactive panel control, so that when it is detected that the current user triggers the interactive control 20, in addition to sending the interactive object corresponding to the interactive control 20 as the target interactive object to the target user, the interactive panel may also be displayed in the target interface, and the interactive object control 40 corresponding to each interactive object may be displayed in the interactive panel, as shown in FIG. 4b (FIG. 4b takes the target interface as an avatar display interface as an example, and the interactive control interaction mode of the user avatar interface shown in FIG. 2 is the same), so that the current user may send the interactive object corresponding to the interactive object control 40 by triggering the interactive object control 40 in the interactive panel. The method for interaction provided in this embodiment may also include: in response to the first interactive object sending operation for the interactive control, displaying the interactive panel, the interactive panel is used to display the interactive object control 40 corresponding to each interactive object in the multiple interactive objects. Among them, the interactive panel displays the interactive object control 40 of the interactive object corresponding to the interactive control.

When the interactive panel is displayed, the interactive panel may be directly displayed on the upper layer of the target interface; or the interactive object control in the interactive panel that is not currently displayed in the target interface can be used to replace one or more other controls in the target interface except the interactive object control for display, such as using the interactive object control in the interactive panel to replace the display of the group shot control and/or the session control in the target interface, which is not limited in this embodiment.

In one implementation, in response to the interactive object sending operation, sending the target interactive object corresponding to the interactive object sending operation to the target user corresponding to the target user avatar, including: in response to the second interactive object sending operation for the interactive control, displaying the interactive panel, wherein the interactive panel is used to display the interactive object control corresponding to each interactive object in the plurality of interactive objects; in response to the triggering operation for any of the interactive object controls, sending the target interactive object corresponding to the triggering operation to the target user corresponding to the target user avatar.

The second interactive object sending operation may be understood as an operation to trigger the interactive control displayed on the target interface, and the second interactive object sending operation has a different triggering mode and/or response mode from the first interactive object sending operation. The interactive object control may be understood as a control used to trigger the sending of its corresponding interactive object.

In the above-mentioned implementation, the interactive control displayed in the target interface may be used to trigger the display of the interactive panel, but not to trigger the sending of the target interactive object.

Exemplarily, when the electronic device detects that the current user triggers the interactive control displayed in the target interface, it may display the interactive panel in the target interface, and display the interactive object control corresponding to each interactive object in the interactive panel, so that when the current user wants to send an interactive object to the target user, the interactive object control corresponding to the interactive object may be triggered in the interactive panel. Correspondingly, when the electronic device detects that the current user triggers an interactive object control, it may send the interactive object corresponding to the interactive object control as the target interactive object to the target user.

S205. In response to the content generation operation, display a media content interface, wherein the media content interface is used to generate and/or publish target media content, and the target media content displays a screen of at least two virtual avatars performing a target group shot action, and the at least two virtual avatars include the virtual avatar of the current user and the avatar of the target user, and end the operation.

The content generation operation can be a triggering operation for generating target media content using the virtual avatar of the current user and the avatar of the target user, such as an operation of triggering the group shot control 21 (as shown in FIGS. 2 and 4a) displayed in the target interface. The group shot control 21 may be displayed when both the user avatar of the current user and the target user avatar are virtual avatars. The target media content may be understood as the media content generated by the virtual avatar of the current user and the target user avatar. The target group shot action may be understood as the group shot action presented by the virtual avatar of the current user and the target user avatar in the target media content. The target group shot action may be a preset group shot action or a group shot action selected by the user in the media content interface.

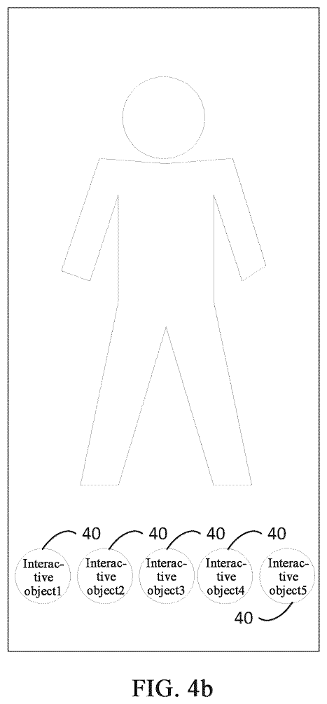

Exemplarily, when the content generation operation of the current user is received, the media content interface may be displayed, and at least two virtual avatars including the virtual avatar of the current user and the target user avatar and at least two group shot action identifiers 50 for the current user to select are displayed in the media content interface, as shown in FIG. 5, so that the current user may trigger a group shot action identifier 50 to instruct the at least two virtual avatars to perform the target group shot action corresponding to the group shot action identifier 50, and may trigger the completion control 51 in the media content interface to generate and/or publish the target media content after the setting is completed. Correspondingly, when the electronic device detects that the current user triggers the completion control 51, it may generate and publish the target media content, or generate the target media content and display the editing interface of the target media content, so that the current user may edit the target media content and publish the edited target media content.

In addition, please continue to refer to FIG. 5, a switching control 52 may also be displayed in the media content interface, so that the current user may switch other virtual avatars displayed in the media content interface except the virtual avatar of the current user by triggering the switching control 52.

S206. In response to the personal profile display operation for the target user, if the target user avatar is a virtual avatar, the personal profile of the target user is displayed, and the target user avatar is displayed in the preset area of the personal profile, and the operation is terminated.

The personal profile display operation can be understood as an operation for triggering the display of the personal profile of the target user, such as an operation for triggering the personal profile control displayed in the target interface. The preset area can be a set area in the personal profile, such as an area in the personal profile for displaying the header avatar of the personal profile, etc., which is not limited in this embodiment.

When the personal profile display operation is received, the current interface is switched from the target interface to the personal profile of the target user, and the target user avatar can be displayed in the preset area of the personal profile. It can be considered whether the target user avatar is a virtual avatar, and the target user avatar can be directly displayed in the preset area of the personal profile; or, it is determined whether the target user avatar is a virtual avatar. If the target user avatar is a virtual avatar, the target user avatar is displayed in the preset area of the personal profile, and if the target user avatar is not a virtual avatar, the target user avatar is not displayed in the preset area of the personal profile.

S207. In response to the conversation operation, displaying the conversation interface between the current user and the target user or displaying the conversation area between the current user and the target user.

When a conversation operation is received, the conversation interface between the current user and the target user or the conversation area between the current user and the target user may be displayed. For example, the current may can be switched from the target interface to the conversation interface between the current user and the target user, or the conversation area between the current user and the target user can be displayed in the target interface, so that the current user may have a conversation with the target user in the conversation interface or conversation area. Among them, the conversation operation can be understood as a trigger operation for indicating the display of the conversation interface or conversation area between the current user and the target user, such as triggering the operation of the conversation control 22 (as shown in FIGS. 2 and 4a) displayed in the target interface.

The method for interaction provided in this embodiment allows the user to perform different types of interactive operations in the target interface, and then perform different types of interactions with the target user corresponding to the target user avatar, which can further enrich the types of interactions supported in the target interface and improve the user experience.

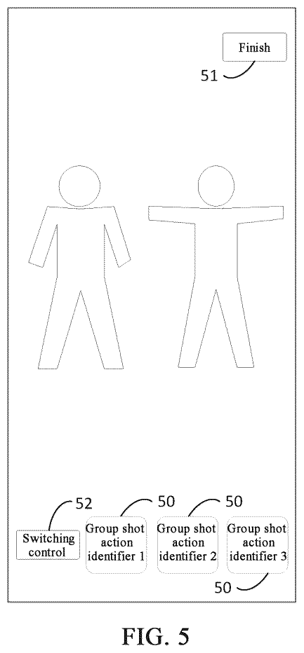

FIG. 6 is a flow chart of another method for interaction provided in the embodiment of the present disclosure. The scheme in this embodiment can be combined with one or more optional schemes in the above embodiments. Alternatively, the step of sending the target interactive object corresponding to the interactive object sending operation to the target user corresponding to the target user avatar includes: displaying the target interactive object corresponding to the interactive object sending operation to move toward the target user avatar, and sending the target interactive object to the target user corresponding to the target user avatar in the form of a conversation message.

Alternatively, before displaying the target interactive object corresponding to the interactive object sending operation to move toward the target user avatar, the step further includes: displaying the target interactive object at a first position corresponding to the interactive object sending operation.

Alternatively, the method for interaction provided in this embodiment also includes: when the target interactive object moves to a second position corresponding to the target user avatar, displaying the target user avatar to perform a target feedback action.

Alternatively, the method for interaction provided in this embodiment also includes: after the target feedback action is performed, displaying the target user avatar to perform a target association action of the target status identification state corresponding to the target user avatar.

As shown in FIG. 6, the method for interaction provided in this embodiment may include:

S301, in response to the display operation, displaying a user avatar interface, wherein the user avatar of at least two users is displayed in the user avatar interface.

S302. determining the target user avatar in the user avatar interface, and the target user avatar is one of the user avatars of the at least two users.

S303. in response to the interactive object sending operation, displaying the target interactive object at the first position corresponding to the interactive object sending operation.

In this embodiment, when the interactive object sending operation for the target interface is detected, the target interactive object may be displayed at the first position corresponding to the interactive object sending operation in the target interface. Among them, the first position may be understood as the position corresponding to the interactive object sending operation in the target interface. For example, the first position may be the position triggered by the interactive object sending operation, or a position near the position triggered by the interactive object sending operation, such as a position above the position triggered by the interactive object sending operation, etc. This embodiment does not limit this.

S304. Displaying the target interactive object corresponding to the interactive object sending operation to move toward the target user avatar, and send the target interactive object to the target user corresponding to the target user avatar in the form of a conversation message.

After the target interactive object is displayed at the first position, the target interactive object can be displayed to move from the first position to the target user avatar, such as from the first position to the head, face, mouth or a position near the target user avatar of the target user avatar, and the target interactive object can be sent to the target user corresponding to the target user avatar in the form of a conversation message.

In one implementation, when the current user continuously sends interactive objects to the target user, the interactive objects continuously sent by the current user to the target user can be counted, and the counting result can be displayed in the target interface to further enrich the content displayed in the target interface when sending interactive objects and enhance the fun of sending interactive objects. Alternatively, after sending the target interactive object corresponding to the interactive object sending operation to the target user corresponding to the target user avatar, it also includes: counting the interactive objects sent by the current user to the target user in the user avatar interface, and displaying the counting result until the interactive object sending operation is not received again within the set time length, wherein the interactive object includes the target interactive object.

The preset time length may be understood as a preset time interval for determining whether the current user continuously sends interactive objects. This embodiment does not limit the specific value of the preset time length. When sending interactive objects continuously, the interactive objects continuously sent by the current user may include the same or different interactive objects, such as the current user may continuously send the target interactive object, or continuously send at least two interactive objects including the target interactive object.

S305. When the target interactive object moves to the second position corresponding to the target user avatar, display the target user avatar to perform a target feedback action.

The target feedback action can be understood as an action for providing feedback to the target interactive object sent by the current user, and the target feedback action can be a preset feedback action or a feedback action set by the target user. Alternatively, the target feedback action corresponds to the target status identification state corresponding to the target interactive object and/or the target user avatar, that is, different feedback actions can be set in advance for different interactive objects or different types of interactive objects, and/or different feedback actions can be set in advance for user avatars corresponding to different target status identifications. The different types of interactive objects may, for example, include interactive objects for expressing different types of statuses, such as interactive objects for expressing positive statuses, interactive objects for expressing neutral statuses, or interactive objects for expressing negative statuses. The second position may be a set position corresponding to the target user avatar in the target interface, such as the head, face, mouth of the target user avatar or a position near the target user avatar, and the second position and the first position may be different positions.

When the target interactive object moves to the second position of the target interface, the target user avatar may be displayed to perform a target feedback action to provide feedback to the current user; the display of the target interactive object may also be canceled.

In this embodiment, the target user avatar may be displayed to perform a target feedback action regardless of whether the target user avatar is a virtual avatar; or the target user avatar may be displayed to perform a target feedback action only when the target user avatar is a virtual avatar, and not when the target user avatar is not a virtual avatar, so as to reduce the control difficulty of the target feedback action, and the control of the target user avatar to perform the target feedback action may include: when the target user avatar is a virtual avatar, displaying the target user avatar to perform the target feedback action.

S306. After the target feedback action is executed, displaying the target user avatar to perform a target-associated action corresponding to the target status identification state of the target user avatar.

The target status identification state may be understood as the status identification state of the target user avatar. The target associated action may be understood as the associated action of the target status identification state.

In this embodiment, before the target interactive object moves to the second position, the target user avatar can may displayed to cyclically execute the target associated action in the target interface; when the target interactive object moves to the second position, the target user avatar may be displayed to stop executing the target associated action, and the target user avatar may be displayed to execute the target feedback action in the target interface, so that after the target feedback action is executed, the target user avatar may be displayed to continue to execute the target associated action.

The execution order of the above multiple steps is only an exemplary execution order, and does not limit multiple execution orders. For example, in this embodiment, the target interactive object may be sent to the target user before the target interactive object is displayed at the first position, while the target interactive object is displayed at the first position, in the process of displaying the target interactive object to move to the target user avatar, when the target interactive object moves to the second position, in the process of displaying the target user avatar to execute the target feedback action, or after the target user avatar is displayed to execute the target feedback action. The specific setting can be flexibly set according to needs.

The method for interaction provided in this embodiment controls the target interactive object to move to the position corresponding to the target user avatar. When the target interactive object moves to the position, the target user avatar is displayed to perform the target feedback action. After the target feedback action is completed, the target user avatar is displayed to perform the associated action of the corresponding status identification state, which may further enrich and improve the sending process of the interactive object and enhance the display effect of the user avatar.

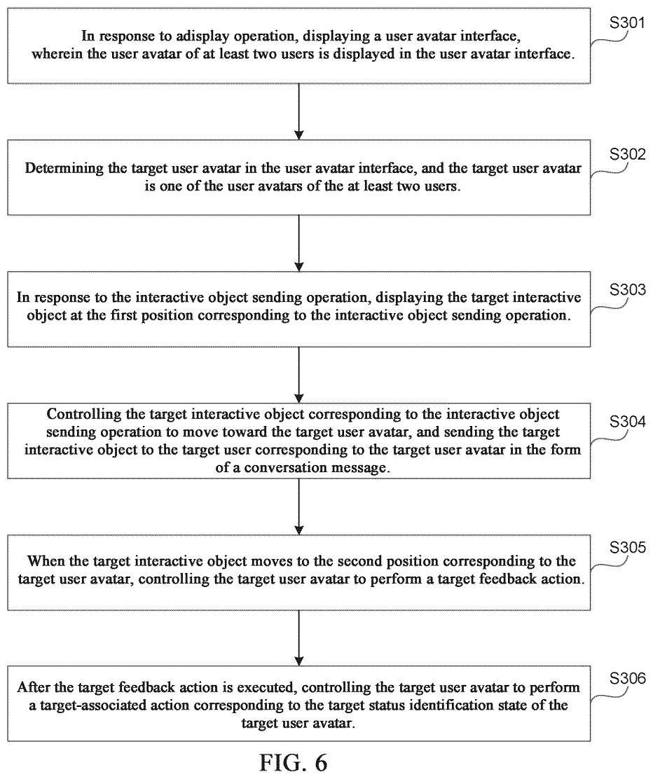

FIG. 7 is a structural block diagram of an apparatus for interaction provided in an embodiment of the present disclosure. The apparatus can be implemented by software and/or hardware, and can be configured in an electronic device, such as a mobile phone or a tablet computer, and different types of interactions can be realized by executing the method for interaction. As shown in FIG. 7, the apparatus for interaction provided in this embodiment may include: an interface display module 701, an avatar determination module 702, and an interactive module 703, wherein the interface display module 701 is configured to display a user avatar interface in response to a display operation, wherein user avatars of at least two users are displayed in the user avatar interface; the avatar determination module 702 is configured to determine a target user avatar, wherein the target user avatar is one of the user avatars of the at least two users; the interactive module 703 is configured to execute an interactive event of a target user corresponding to the target user avatar in response to an interactive operation for the target interface, wherein the target interface supports different types of interactive operations, wherein the different types of interactive operations correspond to different interactive events, and the target interface includes the user avatar interface.

The apparatus for interaction provided in this embodiment displays a user avatar interface in response to the display operation by the interface display module, wherein user avatars of at least two users are displayed in the user avatar interface; determines the target user avatar in the user avatar interface by the avatar determination module, and the target user avatar is one of the user avatars of the at least two users; executes the interactive event of the target user corresponding to the target user avatar in response to the interactive operation for the target interface by the interactive module, and the target interface supports different types of interactive operations, and different types of interactive operations correspond to different types of interactive events, and the target interface includes a user avatar interface. This embodiment adopts the above technical solution to execute different types of interactive events of the target user corresponding to the target user avatar based on different types of interactive actions of the user, and can provide multiple types of method for interactions based on user avatars to meet different needs of users.

In the above solution, the user avatars of the at least two users may be virtual avatars and/or non-virtual avatars corresponding to each of the at least two users.

In the above solution, the interactive operation can include an interactive object sending operation, and the interactive module 703 is configured to: in response to the interactive object sending operation, send the target interactive object corresponding to the interactive object sending operation to the target user corresponding to the target user avatar.

In the above scheme, the interactive module 703 is configured to: display the target interactive object corresponding to the interactive object sending operation to move toward the target user avatar, and send the target interactive object to the target user corresponding to the target user avatar in the form of a conversation message.

In the above scheme, the interactive module 703 is also configured to: display the target interactive object at a first position corresponding to the interactive object sending operation before the target interactive object corresponding to the interactive object sending operation is displayed to move toward the target user avatar.

The apparatus for interaction provided in this embodiment may also include: a feedback module, configured to display the target user avatar to perform a target feedback action when the target interactive object moves to a second position corresponding to the target user avatar.

The apparatus for interaction provided in this embodiment may also include: an object control module, configured to control the target user avatar to perform a target-associated action of the target status identification state corresponding to the target user avatar after the target feedback action is executed.

In the above scheme, the feedback module is configured to: control the target user avatar to perform a target feedback action when the target user avatar is a virtual avatar.

In the above scheme, the target feedback action may correspond to the target status identification state corresponding to the target interactive object and/or the target user avatar.

The apparatus for interaction provided in this embodiment may also include: a counting module, configured to count the interactive objects sent by the current user to the target user in the user avatar interface after sending the target interactive object corresponding to the interactive object sending operation to the target user corresponding to the target user avatar, and display the counting result until the interactive object sending operation is not received again within a set time length, wherein the interactive object includes the target interactive object.

In the above scheme, the interactive module 703 is configured to: in response to the first interactive object sending operation for the interactive control, send the target interactive object corresponding to the first interactive object sending operation to the target user corresponding to the target user avatar.

The apparatus for interaction provided in this embodiment may also include: an interactive panel display module, configured to display an interactive panel in response to the first interactive object sending operation for the interactive control, and the interactive panel is used to display the interactive object control corresponding to each interactive object among multiple interactive objects.

In the above scheme, the interactive module 703 may include: an interactive panel display unit, configured to display an interactive panel in response to a second interactive object sending operation for an interactive control, wherein the interactive panel is used to display an interactive object control corresponding to each interactive object among a plurality of interactive objects; an object sending unit, configured to send a target interactive object corresponding to the trigger operation to a target user corresponding to the target user avatar in response to a trigger operation for any of the interactive object controls.

In the above scheme, the interactive operation may include a content generation operation, and the interactive module 703 is configured to: display a media content interface in response to the content generation operation, wherein the media content interface is used to generate and/or publish target media content, wherein the target media content displays a screen of at least two virtual avatars performing a target co-action action, wherein the at least two virtual avatars include a virtual avatar of the current user and a target user avatar.

In the above scheme, the apparatus for interaction provided in this embodiment may also include: a personal profile display module, configured to display the personal profile of the target user in response to a personal profile display operation for the target user, and display the target user avatar in a preset area of the personal profile when the target user avatar is a virtual avatar.

In the above scheme, the apparatus for interaction provided in this embodiment may also include: a conversation interface display module, configured to display the conversation interface between the current user and the target user or the conversation area between the current user and the target user in response to the conversation operation.

In the above scheme, the avatar determination module 702 is configured to: determine the first user avatar displayed at the third position of the user avatar interface as the target user avatar; or, in response to the trigger operation for the second user avatar displayed in the user avatar interface, determine the second user avatar as the target user avatar, and display the avatar display interface of the target user corresponding to the target user avatar, wherein the avatar display interface is used to display the target user avatar.

The apparatus for interaction provided in this embodiment may also include: an avatar update module, configured to update the user avatar displayed at the third position in response to the update operation acting in the user avatar interface before determining the first user avatar displayed at the third position of the user avatar interface as the target user avatar.

In the above scheme, the avatar update module is configured to: control the movement of at least two user avatars displayed in the user avatar interface, and change the size of each user avatar based on the movement to update the user avatar displayed at the third position.

In the above scheme, the avatar update module is also configured to: in the process of updating the user avatar displayed at the third position, display the user information of the user corresponding to each user avatar displayed in the user avatar interface.

In the above scheme, the display operation may be used for the target user identifier displayed in the preset interface, and the interface display module 701 is configured to: display the user avatar interface, and display the user avatar of the user corresponding to the target user identifier at the third position of the user avatar interface.

The interactive device provided in this embodiment may also include: a setting interface display module, configured to display a virtual avatar setting interface in response to a virtual avatar setting operation, wherein the virtual avatar setting interface is used to set the virtual avatar of the current user.

In the above scheme, the at least two user avatars can be arranged in a curved surface in the user avatar interface.

The interactive device provided in the embodiment of the present disclosure can execute the method for interaction provided in any embodiment of the present disclosure, and has the functional modules and effects corresponding to the execution of the method for interaction. For technical details not described in detail in this embodiment, please refer to the method for interaction provided in any embodiment of the present disclosure.

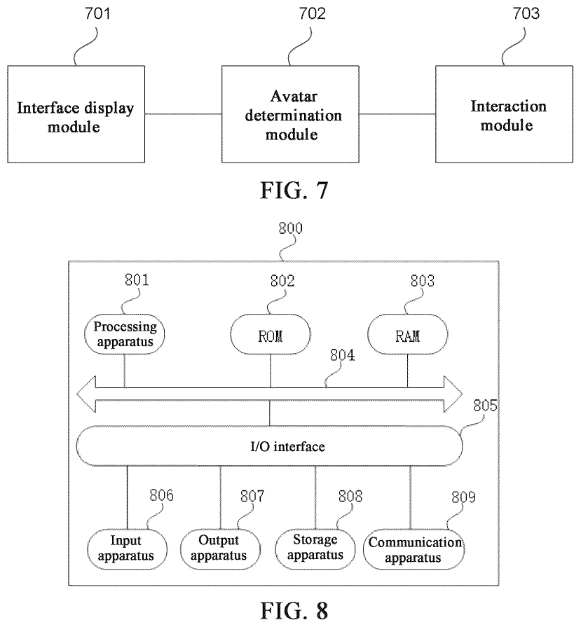

Reference is made to FIG. 8 below, which shows a structural schematic diagram of an electronic device (such as a terminal device) 800 suitable for implementing the embodiment of the present disclosure. The terminal devices in the embodiments of the present disclosure may include but are not limited to mobile terminals such as mobile phones, laptop computers, digital broadcast receivers, personal digital assistants (PDAs), tablet computers (PADs), portable multimedia players (PMPs), vehicle terminals (such as vehicle navigation terminals), etc., and fixed terminals such as digital TVs, desktop computers, etc. The electronic device shown in FIG. 8 is only an example and should not impose any restrictions on the functions and scope of use of the embodiments of the present disclosure.

As shown in FIG. 8, the electronic device 800 may include a processing apparatus (such as a central processing unit, a graphics processor, etc.) 801, and the electronic device 800 may perform a variety of appropriate actions and processes according to a program stored in a read-only memory (ROM) 802 or a program loaded from a storage apparatus 808 to a random access memory (RAM) 803. In RAM 803, a variety of programs and data required for the operation of the electronic device 800 are also stored. The processing apparatus 801, ROM 802, and RAM 803 are connected to each other via a bus 804. An input/output (I/O) interface 805 is also connected to the bus 804.

Typically, the following apparatus may be connected to the I/O interface 805: an input apparatus 806 including, for example, a touch screen, a touchpad, a keyboard, a mouse, a camera, a microphone, an accelerometer, a gyroscope, etc.; an output apparatus 807 including, for example, a liquid crystal display (LCD), a speaker, a vibrator, etc.; a storage apparatus 808 including, for example, a tape, a hard disk, etc.; and a communication apparatus 809. The communication apparatus 809 may allow the electronic device 800 to communicate with other devices wirelessly or wired to exchange data. Although FIG. 8 shows an electronic device 800 having a variety of apparatus, it should be understood that it is not required to implement or have all of the apparatus shown. More or fewer apparatus may be implemented or have alternatively.

According to an embodiment of the present disclosure, the process described above with reference to the flowchart may be implemented as a computer software program. For example, an embodiment of the present disclosure includes a computer program product including a computer program carried on a non-transitory computer-readable medium, the computer program including a program code for executing the method shown in the flowchart. In such an embodiment, the computer program can be downloaded and installed from the network through the communication apparatus 809, or installed from the storage apparatus 808, or installed from the ROM 802. When the computer program is executed by the processing apparatus 801, the above functions defined in the method of the embodiment of the present disclosure are executed.

The computer-readable medium mentioned above in the present disclosure can be a computer-readable signal medium or a computer-readable storage medium or any combination of the above. The computer-readable storage medium can be, for example,-but not limited to-an electrical, magnetic, optical, electromagnetic, infrared, or semiconductor system, apparatus or device, or any combination of the above. The computer-readable storage medium can include, but is not limited to: an electrical connection with one or more wires, a portable computer disk, a hard disk, RAM, ROM, an erasable programmable read-only memory (Electrically Erasable Programmable Read-Only Memory, EPROM) or flash memory, optical fiber, a portable compact disk read-only memory (Compact Disc Read-Only Memory, CD-ROM), an optical storage device, a magnetic storage device, or any suitable combination of the above. In the present disclosure, a computer-readable storage medium may be any tangible medium containing or storing a program that can be used by or in combination with an instruction execution system, apparatus or device. In the present disclosure, a computer-readable signal medium may include a data signal propagated in a baseband or as part of a carrier wave, and the propagated data signal carries a computer-readable program code. Such propagated data signals may take a variety of forms, including but not limited to electromagnetic signals, optical signals, or any suitable combination of the above. A computer-readable signal medium may also be any computer-readable medium other than a computer-readable storage medium, which may send, propagate, or transmit a program for use by or in combination with an instruction execution system, apparatus or device. The program code contained on the computer-readable medium may be transmitted using any appropriate medium, including but not limited to: wires, optical cables, radio frequencies (RF), etc., or any suitable combination of the above.

In some embodiments, the client and the server may communicate using any currently known or future developed network protocol such as the HyperText Transfer Protocol (HTTP), and may be interconnected with digital data communications (e.g., communication networks) of any form or medium. Examples of communication networks include local area networks (LAN), wide area networks (WAN), internets (e.g., the Internet), and peer-to-peer networks (e.g., ad hoc peer-to-peer networks), as well as any currently known or future developed networks.

The computer-readable medium may be included in the electronic device, or may exist separately without being installed in the electronic device.

The computer-readable medium carries one or more programs, and when the one or more programs are executed by the electronic device, the electronic device performs the following method: in response to a display operation, displaying a user avatar interface, wherein user avatars of at least two users are displayed in the user avatar interface; determining a target user avatar on the user avatar interface, wherein the target user avatar is one of the user avatars of the at least two users; in response to an interactive operation for the target interface, executing an interactive event of a target user corresponding to the target user avatar, wherein the target interface supports different types of interactive operations, wherein the different types of interactive operations correspond to different types of interactive events, and the target interface includes the user avatar interface.

Computer program code for performing the operations of the present disclosure may be written in one or more programming languages, including but not limited to object-oriented programming languages such as Java, Smalltalk, C++, and conventional procedural programming languages such as “C” or similar programming languages. The program code may be executed entirely on the user's computer, partially on the user's computer, as a separate software package, partially on the user's computer and partially on a remote computer, or entirely on a remote computer or server. In the case of a remote computer, the remote computer may be connected to the user's computer via any type of network, including a LAN or WAN, or may be connected to an external computer (e.g., via the Internet using an Internet service provider).

The flowcharts and block diagrams in the accompanying drawings illustrate the possible architecture, functions, and operations of the systems, methods, and computer program products according to various embodiments of the present disclosure. In this regard, each box in the flowchart or block diagram may represent a module, program segment, or portion of code, which contains one or more executable instructions for implementing a specified logical function. It should also be noted that in some alternative implementations, the functions marked in the boxes may also occur in a different order than that marked in the drawings. For example, two boxes represented in succession may actually be executed substantially in parallel, and they may sometimes be executed in the opposite order, depending on the functions involved. It should also be noted that each box in the block diagram and/or flowchart, and the combination of boxes in the block diagram and/or flowchart, may be implemented by a dedicated hardware-based system that performs the specified function or operation, or may be implemented by a combination of dedicated hardware and computer instructions.

The units involved in the embodiments described in the present disclosure may be implemented by software or by hardware. The name of the module does not constitute a limitation on the unit itself.

The functions described above in this article may be performed at least in part by one or more hardware logic components. For example, without limitation, exemplary types of hardware logic components that may be used include: Field Programmable Gate Array (FPGA), Application Specific Integrated Circuit (ASIC), Application Specific Standard Product (ASSP), System on Chip (SOC), Complex Programmable Logic Device (CPLD), and the like.

In the context of the present disclosure, a machine-readable medium may be a tangible medium that may contain or store a program for use by or in conjunction with an instruction execution system, apparatus, or device. A machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. A machine-readable storage medium may include an electrical connection based on one or more wires, a portable computer disk, a hard disk, RAM, ROM, EPROM or flash memory, optical fiber, CD-ROM, an optical storage device, a magnetic storage device, or any suitable combination of the foregoing.

According to one or more embodiments of the present disclosure, Example 1 provides an method for interaction, including: in response to a display operation, displaying a user avatar interface, wherein user avatars of at least two user are displayed in the user avatar interface; determining a target user avatar in the user avatar interface, and the target user avatar is one of the user avatars of the at least two users; in response to an interactive operation for the target interface, executing an interactive event of a target user corresponding to the target user avatar, the target interface supporting different types of interactive operations, the different types of interactive operations corresponding to different types of interactive events, and the target interface including the user avatar interface.

According to one or more embodiments of the present disclosure, Example 2 is based on the method of Example 1, wherein the user avatars of the at least two users are virtual avatars and/or non-virtual avatars corresponding to each of the at least two users.

According to one or more embodiments of the present disclosure, Example 3 is based on the method of Example 1, wherein the interactive operation includes an interactive object sending operation, wherein in response to an interactive operation for the target interface, executing an interactive event of a target user corresponding to the target user avatar includes: in response to the interactive object sending operation, sending the target interactive object corresponding to the interactive object sending operation to the target user corresponding to the target user avatar.

According to one or more embodiments of the present disclosure, Example 4 is based on the method of Example 3, wherein sending of the target interactive object corresponding to the interactive object sending operation to the target user corresponding to the target user avatar includes: displaying the target interactive object corresponding to the interactive object sending operation to move toward the target user avatar, and sending the target interactive object to the target user corresponding to the target user avatar in the form of a conversation message.

According to one or more embodiments of the present disclosure, Example 5 is based on the method of Example 4, and before displaying of the target interactive object corresponding to the interactive object sending operation to move toward the target user avatar, it also includes: displaying the target interactive object at a first position corresponding to the interactive object sending operation.

According to one or more embodiments of the present disclosure, Example 6 is based on the method of Example 4, and further includes: when the target interactive object moves to a second position corresponding to the target user avatar, displaying the target user avatar to perform a target feedback action.

According to one or more embodiments of the present disclosure, Example 7 is based on the method of Example 6, and further includes: after the target feedback action is executed, displaying the target user avatar to perform a target association action corresponding to the target status identification state of the target user avatar.

According to one or more embodiments of the present disclosure, Example 8 is based on the method of Example 6, wherein displaying the target user avatar to perform the target feedback action includes: when the target user avatar is a virtual avatar, displaying the target user avatar to perform the target feedback action.

According to one or more embodiments of the present disclosure, Example 9 is based on the method of Example 6, wherein the target feedback action corresponds to the target status identification state corresponding to the target interactive object and/or the target user avatar.

According to one or more embodiments of the present disclosure, Example 10 is based on the method of Example 3, after the target interactive object corresponding to the interactive object sending operation is sent to the target user corresponding to the target user avatar, it also includes: counting the interactive objects sent by the current user to the target user in the user avatar interface, and displaying the counting result until the interactive object sending operation is not received again within the set time length, wherein the interactive object includes the target interactive object.

According to one or more embodiments of the present disclosure, Example 11 is based on the method of Example 3, wherein in response to the interactive object sending operation, sending the target interactive object corresponding to the interactive object sending operation to the target user corresponding to the target user avatar, including: in response to the first interactive object sending operation for the interactive control, sending the target interactive object corresponding to the first interactive object sending operation to the target user corresponding to the target user avatar.

According to one or more embodiments of the present disclosure, Example 12 is based on the method of Example 11, further comprising: in response to the first interactive object sending operation for the interactive control, displaying an interactive panel, wherein the interactive panel is used to display the interactive object control corresponding to each interactive object in a plurality of interactive objects.

According to one or more embodiments of the present disclosure, Example 13 is based on the method of Example 3, wherein in response to the interactive object sending operation, sending the target interactive object corresponding to the interactive object sending operation to the target user corresponding to the target user avatar, including: in response to the second interactive object sending operation for the interactive control, displaying an interactive panel, wherein the interactive panel is used to display the interactive object control corresponding to each interactive object in a plurality of interactive objects; in response to the trigger operation for any of the interactive object controls, sending the target interactive object corresponding to the trigger operation to the target user corresponding to the target user avatar.

According to one or more embodiments of the present disclosure, Example 14 is based on the method of Example 1, wherein the interactive operation includes a content generation operation, and in response to the interactive operation for the target interface, executing the interactive event of the target user corresponding to the target user avatar, including: in response to the content generation operation, displaying a media content interface, wherein the media content interface is used to generate and/or publish target media content, and the target media content displays a screen of at least two virtual avatars performing a target co-action action, and the at least two virtual avatars include the virtual avatar of the current user and the target user avatar.

According to one or more embodiments of the present disclosure, Example 15 is based on the method of Example 1, further comprising: in response to the personal profile display operation for the target user, when the target user avatar is a virtual avatar, displaying the personal profile of the target user, and displaying the target user avatar in a preset area of the personal profile.

According to one or more embodiments of the present disclosure, Example 16 is based on the method of Example 1, further comprising: in response to the conversation operation, displaying the conversation interface of the current user with the target user or displaying the conversation area of the current user with the target user.

According to one or more embodiments of the present disclosure, Example 17 is a method according to any of Examples 1-16, wherein determining the target user avatar in the user avatar interface includes: determining the first user avatar displayed at the third position of the user avatar interface as the target user avatar; or in response to a trigger operation for the second user avatar displayed in the user avatar interface, determining the second user avatar as the target user avatar, and displaying the avatar display interface of the target user corresponding to the target user avatar, wherein the avatar display interface is used to display the target user avatar.

According to one or more embodiments of the present disclosure, Example 18 is a method according to Example 17, and before determining the first user avatar displayed at the third position of the user avatar interface as the target user avatar, it also includes: in response to an update operation acting in the user avatar interface, updating the user avatar displayed at the third position.

According to one or more embodiments of the present disclosure, Example 19 is a method according to Example 18, wherein updating the user avatar displayed at the third position includes: displaying at least two user avatars displayed in the user avatar interface to move, and changing the size of each user avatar based on the movement to update the user avatar displayed at the third position.

According to one or more embodiments of the present disclosure, Example 20 is based on the method of Example 18, further comprising: in the process of updating the user avatar displayed at the third position, displaying the user information of the user corresponding to each user avatar displayed in the user avatar interface.

According to one or more embodiments of the present disclosure, Example 21 is based on the method of Example 18, the display operation acts on the target user identifier displayed in the preset interface, and displaying the user avatar interface includes: displaying the user avatar interface, and displaying the user avatar of the user corresponding to the target user identifier at the third position of the user avatar interface.

According to one or more embodiments of the present disclosure, Example 22 is based on any of the methods of Examples 1-16, further comprising: in response to the virtual avatar setting operation, displaying the virtual avatar setting interface, wherein the virtual avatar setting interface is used to set the virtual avatar of the current user.

According to one or more embodiments of the present disclosure, Example 23 is based on any of the methods of Examples 1-16, and the at least two user avatars are arranged in a curved surface in the user avatar interface.

According to one or more embodiments of the present disclosure, Example 24 provides an apparatus for interaction, including: an interface display module, configured to display a user avatar interface in response to a display operation, wherein user avatars of at least two users are displayed in the user avatar interface; an avatar determination module, configured to determine a target user avatar, wherein the target user avatar is one of the user avatars of the at least two users; an interactive module, configured to execute an interactive event of a target user corresponding to the target user avatar in response to an interactive operation for the target interface, the target interface supporting different types of interactive operations, the different types of interactive operations corresponding to different interactive events, and the target interface including the user avatar interface.

According to one or more embodiments of the present disclosure, Example 25 provides an electronic device, including: one or more processors; a memory, configured to store one or more programs; when the one or more programs are executed by the one or more processors, the one or more processors implement a method for interaction as described in any one of Examples 1-23.

According to one or more embodiments of the present disclosure, Example 26 provides a computer-readable storage medium, wherein a computer program is stored thereon, and when the program is executed by the processor, a method for interaction as described in any one of Examples 1-23 is implemented.

1. An method for interaction, comprising:
in response to a display operation, displaying a user avatar interface, wherein user avatars of at least two users are displayed in the user avatar interface;
determining a target user avatar in the user avatar interface, wherein the target user avatar is one of the user avatars of the at least two users; and
in response to an interactive operation for a target interface, executing an interactive event of a target user corresponding to the target user avatar, the target interface supporting different types of interactive operations, the different types of interactive operations corresponding to different types of interactive events, and the target interface including the user avatar interface.

2. The method of claim 1, wherein the user avatars of the at least two users are at least one of a virtual avatar and a non-virtual avatar corresponding to each of the at least two users.

3. The method of claim 1, wherein the interactive operation includes an interactive object sending operation, wherein in response to an interactive operation for the target interface, executing an interactive event of a target user corresponding to the target user avatar comprises:
in response to the interactive object sending operation, sending a target interactive object corresponding to the interactive object sending operation to the target user corresponding to the target user avatar.

4. The method of claim 3, wherein sending the target interactive object corresponding to the interactive object sending operation to the target user corresponding to the target user avatar comprises:
displaying the target interactive object corresponding to the interactive object sending operation to move toward the target user avatar, and sending the target interactive object to the target user corresponding to the target user avatar in a form of a conversation message.

5. The method of claim 4, wherein before displaying the target interactive object corresponding to the interactive object, sending operation to move toward the target user avatar, the method further comprises:
displaying the target interactive object at a first position corresponding to the interactive object sending operation.

6. The method of claim 4, further comprises:
displaying the target user avatar to perform a target feedback action in response to the target interactive object moving to a second position corresponding to the target user avatar.

7. The method of claim 6, further comprises:
displaying the target user avatar to perform a target association action corresponding to a target status identification state of the target user avatar after the target feedback action is performed.

8. The method of claim 6, wherein displaying the target user avatar to perform the target feedback action comprises:
in response to the target user avatar is a virtual avatar, displaying the target user avatar to perform the target feedback action.

9. The method of claim 6, wherein the target feedback action corresponds to at least one of the target status identification states corresponding to the target interactive object and the target user avatar.

10. The method of claim 3, wherein after the target interactive object corresponding to the interactive object sending operation is sent to the target user corresponding to the target user avatar, the method further comprises:
counting the interactive objects sent by a current user to the target user in the user avatar interface, and displaying a counting result until the interactive object sending operation is not received again within a set time length, wherein the interactive object includes the target interactive object.

11. The method of claim 3, wherein in response to the interactive object sending operation, sending the target interactive object corresponding to the interactive object sending operation to the target user corresponding to the target user avatar comprises:
in response to the first interactive object sending operation for an interactive control, sending the target interactive object corresponding to the first interactive object sending operation to the target user corresponding to the target user avatar.

12. The method of claim 11, further comprises:
in response to the first interactive object sending operation for the interactive control, displaying an interactive panel, the interactive panel being used to display the interactive object control corresponding to each interactive object in a plurality of interactive objects.

13. The method of claim 3, wherein in response to the interactive object sending operation, sending the target interactive object corresponding to the interactive object sending operation to the target user corresponding to the target user avatar comprises:
in response to a second interactive object sending operation for an interactive control, displaying an interactive panel, wherein the interactive panel is configured to display the interactive object control corresponding to each interactive object in a plurality of interactive objects; and
in response to a trigger operation for any of the interactive object controls, sending the target interactive object corresponding to the trigger operation to the target user corresponding to the target user avatar.

14. The method of claim 1, wherein the interactive operation includes a content generation operation, and in response to the interactive operation for the target interface, executing the interactive event of the target user corresponding to the target user avatar comprises:
in response to a content generation operation, displaying a media content interface, wherein the media content interface is configured to execute at least one of: generating target media content; and publishing target media content, the target media content displaying a screen of at least two virtual avatars performing a target co-action action, and the at least two virtual avatars including the virtual avatar of the current user and the target user avatar.

15. The method of claim 1 further comprises:
in response to a personal profile display operation for the target user and the target user avatar being a virtual avatar, displaying a personal profile of the target user, and displaying the target user avatar in a preset area of the personal profile;
in response to a conversation operation, displaying a conversation interface of a current user with the target user or displaying a conversation area of the current user with the target user.

16. (canceled)

17. The method claim 1, wherein determining the avatar of the target user in the user avatar interface comprises:
determining a first user avatar displayed at a third position of the user avatar interface as the target user avatar; or
in response to a trigger operation for the second user avatar displayed in the user avatar interface, determining the second user avatar as the target user avatar, and displaying an avatar display interface of the target user corresponding to the target user avatar, wherein the avatar display interface is configured to display the target user avatar;
wherein before determining the first user avatar displayed at the third position of the user avatar interface as the target user avatar, the method further comprises:
in response to an update operation acting in the user avatar interface, updating the user avatar displayed at the third position;
wherein updating the user avatar displayed at the third position comprises:
displaying at least two user avatars displayed in the user avatar interface to move, and changing the size of each user avatar based on the movement to update the user avatar displayed at the third position.

18. (canceled)

19. (canceled)

20. The method of claim 17, further comprises:
in a process of updating the user avatar displayed at the third position, displaying the user information of the user corresponding to each user avatar displayed in the user avatar interface;
wherein the display operation acts on the target user identifier displayed in the preset interface, and displaying the user avatar interface comprises:
displaying a user avatar interface, and displaying the user avatar of the user corresponding to the target user identifier at the third position of the user avatar interface.

21. (canceled)

22. The method of claim 1, further comprising:
in response to a virtual avatar setting operation, displaying a virtual avatar setting interface, wherein the virtual avatar setting interface is used to set the virtual avatar of the current user; and
wherein the at least two user avatars are arranged in a curved surface in the user avatar interface.

23. (canceled)

24. (canceled)

25. An electronic device, comprising:
at least one processor; and
a memory communicatively connected to the at least one processor; wherein the memory stores a computer program executable by the at least one processor, the computer program being executed by the at least one processor causing the at least one processor to:
in response to a display operation, display a user avatar interface, wherein user avatars of at least two users are displayed in the user avatar interface;
determine a target user avatar in the user avatar interface, wherein the target user avatar is one of the user avatars of the at least two users; and
in response to an interactive operation for a target interface, execute an interactive event of a target user corresponding to the target user avatar, the target interface supporting different types of interactive operations, the different types of interactive operations corresponding to different types of interactive events, and the target interface including the user avatar interface.

26. A non-transitory computer-readable storage medium, the computer-readable storage medium storing computer instructions thereon, the computer instructions being configured to, when executed, cause the processor to;
in response to a display operation, display a user avatar interface, wherein user avatars of at least two users are displayed in the user avatar interface;
determine a target user avatar in the user avatar interface, wherein the target user avatar is one of the user avatars of the at least two users; and
in response to an interactive operation for a target interface, execute an interactive event of a target user corresponding to the target user avatar, the target interface supporting different types of interactive operations, the different types of interactive operations corresponding to different types of interactive events, and the target interface including the user avatar interface.
